(19) United States
(12) Patent Application Publication
(10) Pub. No.: US 2016/0101532 A1
(43) Pub. Date: Apr. 14, 2016

(54) SMALL SIZE RAZOR SYSTEM

(71) Applicant: Alice Chang, South Pasadena, CA (US)

(72) Inventor: Alice Chang, South Pasadena, CA (US)

(21) Appl. No.: 14/512,460

(22) Filed: Oct. 12, 2014

(51) Int. Cl. B26B 21/52; B26B 21/16; B26B 21/46; B26B 21/20; B26B 21/40; B26B 21/10; B26B 21/18

(52) U.S. Cl. CPC B26B 21/522; B26B 21/10; B26B 21/16; B26B 21/18; B26B 21/20; B26B 21/4037; B26B 21/4056; B26B 21/46

(57) ABSTRACT

The small size razor system is created to shave hair in small areas, comprising a razor device having a razor head, at least one razor blade, and a handle. The razor head having at least one razor blade. The razor head is connected to the handle. The razor device is selected from group consisting of manual, and electric. The razor device is created in a variety of shapes and sizes. It is more convenient and easy for the shaving person to shave hair in small areas such as armpit and nostril with the small size razor system.

### CROSS-REFERENCE TO RELATED APPLICATION

### Copyright Notice

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

The following includes information that may be useful in understanding the present invention(s). It is not an admission that any of the information provided herein is prior art, or material, to the presently described or claimed inventions, or that any publication or document that is specifically or implicitly referenced is prior art.

### BACKGROUND OF THE INVENTION

1. Field of the Invention

The present invention relates generally to the field of razor and shaver.

2. Description of the Related Art

Currently on the market, razor and shaver are very limited in the selection of shapes and sizes.

Various attempts have been made to solve the above-mentioned problems such as those found in U.S. Pat. No. 2,139,680; U.S. Publication Nos. 2013/0247393; and U.S. Publication No. 2002/0062568. This prior art is representative of razor and shaver. None of the above inventions and patents, taken either singly or in combination, is seen to describe the invention as claimed.

Ideally, razor and shaver are created with a wide range of shapes and sizes and yet manufactured at a modest expense.

### BRIEF SUMMARY OF THE INVENTION

In view of the foregoing disadvantages inherent in the known related razor and shaver, the present invention provides razor and shaver created with a wide range of shapes and sizes, including small size razor system. It is more convenient and easy for the shaving person to shave hair in small areas such as armpit and nostril with the small size razor system.

The small size razor system is configured to shave hair in small areas, comprising a razor device having a razor head, at least one razor blade, and a handle. The razor head having at least one razor blade. The razor head is connected to the handle. The razor device is selected from group consisting of manual, and electric.

The present invention holds significant improvements and serves as razor and shaver with a wide range of shapes and sizes, including small size razor system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, small size razor system, constructed and operative according to the teachings of the present invention.

FIG. 1 shows a perspective view illustrating a small size razor system in an in-use condition according to an embodiment of the present invention.

FIG. 2 is a front perspective view illustrating a small size razor system according to an embodiment of the present invention of FIG. 1.

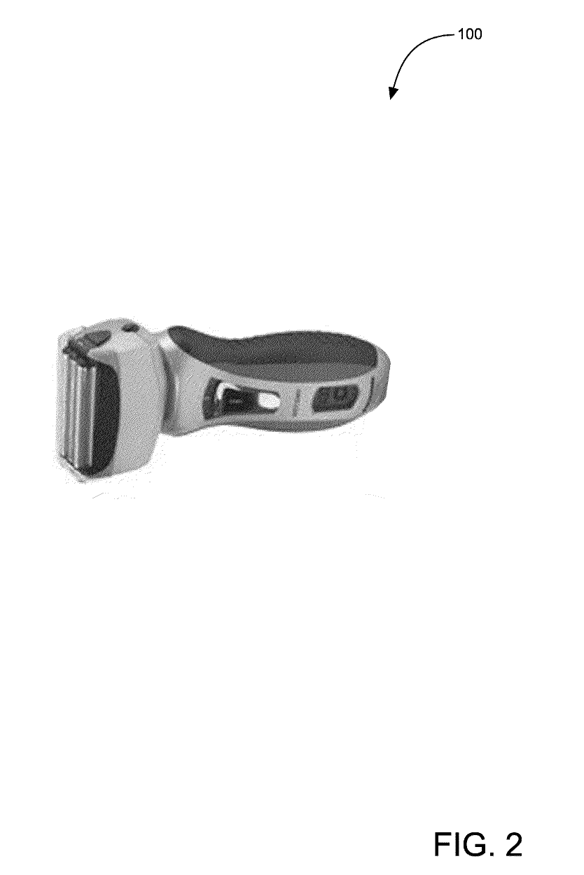

The various embodiments of the present invention will hereinafter be described in conjunction with the appended drawings, wherein like designations denote like elements

### DETAILED DESCRIPTION

As discussed above, embodiments of the present invention provides razor and shaver created with a wide range of shapes and sizes, including small size razor system 100. It is more convenient and easy for the shaving person to shave hair in small areas such as armpit and nostril with the small size razor system 100.

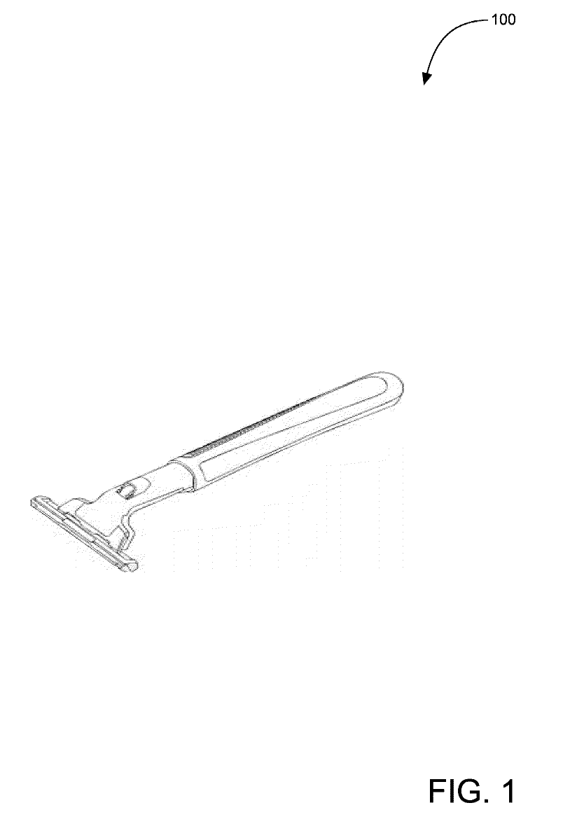

Referring to drawings, FIGS. 1 & 2, the small size razor system 100 is configured to shave hair in small areas, comprising a razor device having a razor head, at least one razor blade, and a handle. The razor head having at least one razor blade. The razor head is connected to the handle. The razor device is selected from group consisting of manual, and electric.

The razor head having at least one straight razor blade with a length of about 2 mm to 3 cm, and a width of about 1 mm to 2 cm. At least one straight razor blade is selected from group consisting of perpendicular to the handle, parallel to the handle, and angular to the handle. At least one straight razor blade is arranged parallel to one another.

The razor head having at least one round razor blade with a diameter of about 2 mm to 3 cm. At least one round razor blade is selected from group consisting of perpendicular to the handle, parallel to the handle, and angular to the handle. At least one round razor blade is arranged side by side in a row.

The razor head having at least one curved razor blade with a length of about 2 mm to 3 cm, and a width of about 1 mm to 2 cm. At least one curved razor blade is selected from group consisting of perpendicular to the handle, parallel to the handle, and angular to the handle. At least one curved razor blade is arranged parallel to one another.

At least one razor blade is selected from group consisting of having jagged edge, smooth edge, sharp edge, single edge, double edges, edge on one side, edges on two sides, edges on three sides, and edges on all sides. At least one razor blade having a shape selected from group consisting of geometrical and non geometrical shapes. The geometrical shapes are selected from group consisting of rectangle, square, ellipse, oval, circle, and round.

At least one razor blade having longer dimension selected from group consisting of about 3 to 8 cm in length, and 3 to 8 cm in diameter.

At least one razor blade can be removed and replaced.

The razor device is electric, having a motor, having one or more batteries housed in the handle, and having electrical connections from within the handle to the razor head.

The razor device is electric, and having one or more batteries selected from group consisting of rechargeable battery, and disposable battery.

The razor device is electric, and having a battery indicator indicating battery is a state selected from group consisting of being fully charged, and needing a recharge.

The razor device is electric, and having rechargeable stand for recharging battery.

The razor device is electric, and having a switch on the handle to turn the razor device on and off.

The razor device is electric, and having motion selected from group consisting of vibrations, pulses, and rotations.

The razor device is electric, and having light for illumination in area selected from group consisting of razor head, and handle.

The razor device is electric, having razor head removable for cleaning, and having at least one thin layer of wire mesh casing at least one razor blade.

The razor head having a shape selected from group consisting of geometrical shapes and non geometrical shapes. The geometrical shapes are selected from group consisting of cylinder, cube, sphere, disc, rectangle, square, ellipse, oval, circle, and round.

The razor head having connection to said handle selected from group consisting of perpendicular, parallel, and angular.

The handle is selected from group consisting of having 4 edges, having curved surface, having rubber on surface for easy gripping, and having a length of about 2 to 20 cm.

The razor device is selected from group consisting of wet use, and dry use.

The razor device having material selected from group consisting of plastic, glass, and metal. The razor device having a container selected from group consisting of bag, and box. The razor head having a cover selected from group consisting of transparent plastic cover, opaque plastic cover, glass cover, and metal cover.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. The small size razor system is configured to shave hair in small areas comprising:
a razor device having:
a razor head,
at least one razor blade, and
a handle;
wherein said razor head having at least one razor blade;
wherein said razor head is connected to said handle; and
wherein said razor device is selected from group consisting of manual, and electric.

2. The small size razor system of claim 1 wherein said razor head having at least one straight razor blade with a length of about 2 mm to 3 cm, and a width of about 1 mm to 2 cm; said at least one straight razor blade is selected from group consisting of perpendicular to said handle, parallel to said handle, and angular to said handle; and said at least one straight razor blade is arranged parallel to one another.

3. The small size razor system of claim 1 wherein said razor head having at least one round razor blade with a diameter of about 2 mm to 3 cm; said at least one round razor blade is selected from group consisting of perpendicular to said handle, parallel to said handle, and angular to said handle; and said at least one round razor blade is arranged side by side in a row.

4. The small size razor system of claim 1 wherein said razor head having at least one curved razor blade with a length of about 2 mm to 3 cm, and a width of about 1 mm to 2 cm; said at least one curved razor blade is selected from group consisting of perpendicular to said handle, parallel to said handle, and angular to said handle; and said at least one curved razor blade is arranged parallel to one another.

5. The small size razor system of claim 1 wherein said at least one razor blade is selected from group consisting of having jagged edge, smooth edge, sharp edge, single edge, double edges, edge on one side, edges on two sides, edges on three sides, and edges on all sides; said at least one razor blade having a shape selected from group consisting of geometrical and non geometrical shapes; and said geometrical shapes are selected from group consisting of rectangle, square, ellipse, oval, circle, and round.

6. The small size razor system of claim 1 wherein said at least one razor blade having longer dimension selected from group consisting of about 3 to 8 cm in length, and 3 to 8 cm in diameter.

7. The small size razor system of claim 1 wherein said at least one razor blade can be removed and replaced.

8. The small size razor system of claim 1 wherein said razor device is electric, having a motor, having one or more batteries housed in said handle, and having electrical connections from within said handle to said razor head.

9. The small size razor system of claim 1 wherein said razor device is electric, and having one or more batteries selected from group consisting of rechargeable battery, and disposable battery.

10. The small size razor system of claim 1 wherein said razor device is electric, and having a battery indicator indicating battery in a state selected from group consisting of being fully charged, and needing a recharge.

11. The small size razor system of claim 1 wherein said razor device is electric, and having rechargeable stand for recharging battery.

12. The small size razor system of claim 1 wherein said razor device is electric, and having a switch on said handle to turn said razor device on and off.

13. The small size razor system of claim 1 wherein said razor device is electric, and having motion selected from group consisting of vibrations, pulses, and rotations.

14. The small size razor system of claim 1 wherein said razor device is electric, and having light for illumination in area selected from group consisting of said razor head, and said handle.

15. The small size razor system of claim 1 wherein said razor device is electric, having said razor head removable for cleaning, and having at least one thin layer of wire mesh casing said at least one razor blade.

16. The small size razor system of claim 1 wherein said razor head having a shape selected from group consisting of geometrical shapes and non geometrical shapes; and said geometrical shapes are selected from group consisting of cylinder, cube, sphere, disc, rectangle, square, ellipse, oval, circle, and round.

17. The small size razor system of claim 1 wherein said razor head having connection to said handle selected from group consisting of perpendicular, parallel, and angular.

18. The small size razor system of claim 1 wherein said handle is selected from group consisting of having 4 edges, having curved surface, having rubber on surface for easy gripping, and having a length of about 2 to 20 cm.

19. The small size razor system of claim 1 wherein said razor device is selected from group consisting of wet use, and dry use.

20. The small size razor system of claim 1 wherein said razor device having material selected from group consisting of plastic, glass, and metal; said razor device having a container selected from group consisting of bag, and box; and said razor head having a cover selected from group consisting of transparent plastic cover, opaque plastic cover, glass cover, and metal cover.
